(19) United States
(12) Patent Application Publication
(10) Pub. No.: US 2025/0055025 A1
(43) Pub. Date: Feb. 13, 2025

(54) SOLID MATERIAL COMPRISING LI, MG, P, S AND HALOGEN ELEMENTS

(71) Applicant: SPECIALTY OPERATIONS FRANCE, Lyon (FR)

(72) Inventors: Antoine Emery, Brussels (BE); Marc-David Braida, Bry-sur-Marne (FR); Thierry Le Mercier, Rosny-sous-Bois (FR); Nicola Marzari, Lausanne VD (CH); Sokseiha Muy, Lausanne VD (CH); Loris Ercole, St-Sulpice VD (CH)

(73) Assignee: SPECIALTY OPERATIONS FRANCE, Lyon (FR)

(21) Appl. No.: 18/721,112

(22) PCT Filed: Dec. 14, 2022
(86) PCT No.: PCT/EP2022/085960

§ 371 Date: Jun. 17, 2024

(30) Foreign Application Priority Data
Dec. 17, 2021 (EP) 21306820.8

(51) Int. Cl. H01M 10/0562; C01B 25/14; H01M 10/0525; H01M 50/431; H01M 50/446; H01M 50/46

(52) U.S. Cl. CPC H01M 10/0562; C01B 25/14; H01M 10/0525; H01M 50/431; H01M 50/446; H01M 50/461; C01P 2004/51; C01P 2006/40; H01M 2300/008

(57) ABSTRACT

The present invention pertains to a solid material according to general formula (I) as follows and to a method for producing said solid material:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6.

The present disclosure also refers to the use of this solid material as solid electrolyte notably for electrochemical devices such as batteries.

This application claims priority to European patent application No. 21306820.8 filed on Dec. 17, 2021, the whole content of this application being incorporated herein by reference for all purposes.

The present invention pertains to a solid material according to general formula (I) as follows and to a method for producing said solid material:

Li_{7-2x-y}MgₓPS_{6-y}X_{y} (1)

wherein:
X is a halogen selected from the group consisting of F, Cl, I and Br or a combination thereof;
x is a number such as 0.01≤x≤0.35 and
y is a number such as 1.3≤y≤1.6.

The present disclosure also refers to the use of this solid material as solid electrolyte notably for electrochemical devices such as batteries.

### PRIOR ART

Lithium batteries are used to power portable electronics and electric vehicles owing to their high energy and power density. Conventional lithium batteries make use of a liquid electrolyte that is composed of a lithium salt dissolved in an organic solvent. The aforementioned system raises security questions as the organic solvents are flammable. Lithium dendrites forming and passing through the liquid electrolyte medium can cause short circuits and produce heat, which result in accidents that lead to serious injuries. Since the electrolyte solution is a flammable liquid, there is a concern of occurrence of leakage, ignition or the like when used in a battery. Taking such concern into consideration, development of a solid electrolyte having a higher degree of safety is expected as an electrolyte for a next-generation lithium battery.

Non-flammable inorganic solid electrolytes offer a solution to the security problem. Furthermore, their mechanical stability helps suppressing lithium dendrite formation, preventing self-discharge and heating problems, and prolonging the life-time of a battery.

Solid sulfide electrolytes are advantageous for lithium battery applications due to their high ionic conductivities and mechanical properties. These electrolytes can be pelletized and attached to electrode materials by cold pressing, which eliminates the necessity of a high temperature assembly step. Elimination of the high temperature sintering step removes one of the challenges against using lithium metal anodes in lithium batteries. Because of the wide-spread use of all solid state lithium batteries, there is an increasing demand for solid state electrolytes having a high conductivity for lithium ions. An important class of such solid electrolytes are materials of the composition Li₆PS₅X (X═Cl, Br) which have an argyrodite structure. Sulfide-based solid electrolytes such as Li₆PS₅X (X═Cl, Br, 1) with an argyrodite crystal structure are superionic conductors with high electrochemical stability and ionic conductivity. Because of these interesting properties, such materials are the subject matter of numerous studies, some of them involving the use of dopants. US 2021/047195 describes the use of thiophilic metals, such as Mn, Fe, Co, Ni, Cu, Zn, Hg and Mo, to modify the structure of argyrodite to prevent the formation of H₂S, thus stabilizing the materials.

US 2020/0194827 describes a sulfide based solid electrolyte doped with an alkaline earth metal for improving the ionic conductivity thereof and a method of manufacturing the same. The sulfide based solid electrolyte represented by the formula Li₆₋₂ₓMeₓPS₅Ha, wherein Me is an alkaline rare earth element, Ha is a halogen element and 0<x≤0.5, exhibits higher ionic conductivity than undoped argyrodite of formula Li₆PS₅Cl. However, the increase of the ionic conductivity is rather limited.

WO2021117869 describes a sulfide based solid electrolyte doped with several metals for improving resistance to moisture and reducing generation of H₂S while maintaining the ionic conductivity thereof and a method of manufacturing the same. The sulfide based solid electrolyte is represented by the formula LiₐM_{b}PS_{c}X_{d}, wherein 3.0≤a≤6.5, 0<b≤2.0, 3.5≤c≤5.5 and 0.5≤d≤3.0, wherein X is halogen and wherein M can be Mg. However, the measured ionic conductivities are also rather limited for exemplified Mg containing sulfides.

There is however a need for new solid sulfide electrolytes having optimized performances, such as higher ionic conductivity and lower activation energy, without compromising other important properties like chemical and mechanical stability.

### INVENTION

Surprisingly it has been found that new solid sulfide electrolytes LiMgPSX of well-defined compositions, that will be detailed in the following, have higher ionic conductivity and lower activation energy in comparison i) with usual Li₆PS₅Cl materials and ii) with LiMgPSX solid materials disclosed in prior art. The LiMgPSX solid materials of the invention also exhibits at least similar chemical and mechanical stability and processability like those conventional lithium argyrodites. Solid materials of the invention may also be prepared with improved productivity and allowing a control of the morphology of the obtained product.

The present invention refers to a solid material according to general formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6.

The invention also concerns process for the preparation of a solid material according to general formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6, comprising the steps of:
a) obtaining a composition by admixing the raw materials, optionally in one or more solvents;
b) optionally applying a mechanical treatment to the composition obtained in step a);
c) optionally removing at least a portion of the one or more solvents from the composition obtained on step b), so that to obtain a solid residue;
d) optionally pressing the solid residue from step c) into pellets;
e) heating the obtained residue obtained in step c) e.g. in the form of pellets, to a temperature in the range of from 350° C. to 580° C., for a period ranging from 1 to 12 hours, thereby forming the solid material; and
f) optionally treating the solid material obtained in step e) to the desired particle size distribution.

The invention also concerns process for the preparation of a solid material according to general formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6, comprising the steps of:
a′) obtaining a solution by admixing the raw materials in one or more solvents;
b′) removing at least a portion of the one or more solvents from the composition obtained in step a′), so that to obtain a solid residue;
c′) optionally pressing the solid residue from step b′) into pellets;
d′) optionally heating the obtained residue obtained in step b′) e.g. in the form of pellets, to a temperature in the range of from 350° C. to 580° C., under an inert atmosphere, for a time period ranging from 1 to 12 hours, thereby forming the solid material; and
e′) optionally treating the solid material obtained in step d′) to the desired particle size distribution.

The invention furthermore concerns a solid material susceptible to be obtained by said processes.

The invention also refers to the use of a solid material of formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6;
as solid electrolyte.

The invention also refers to a solid electrolyte comprising at least a solid material of formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6.

The invention also concerns an electrochemical device comprising at least a solid electrolyte comprising at least a solid material of formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6.

The invention also refers to a solid state battery comprising at least a solid electrolyte comprising at least a solid material of formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6.

The present invention also concerns a vehicle comprising at least a solid state battery comprising at least a solid electrolyte comprising at least a solid material of formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6.

The present invention also concerns an electrode comprising at least:
a metal substrate;
directly adhered onto said metal substrate, at least one layer made of a composition comprising:
(i) a solid material of formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6;
(ii) at least one electro-active compound (EAC);
(iii) optionally at least one lithium ion-conducting material (LiCM) other than the solid material of the invention;
(iv) optionally at least one electro-conductive material (ECM);
(v) optionally a lithium salt (LIS);
(vi) optionally at least one polymeric binding material (P).

The present invention also concerns a separator comprising at least:
a solid material of formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6;
optionally at least one polymeric binding material (P);
optionally at least one metal salt, notably a lithium salt;
optionally at least one plasticizer.

### Definitions

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”. As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits. Ratios, concentrations, amounts, and other numerical data may be is presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example. The term “electrolyte” refers in particular to a material that allows ions, e.g., Li⁺, to migrate therethrough but which does not allow electrons to conduct therethrough. Electrolytes are useful for electrically isolating the cathode and anodes of a battery while allowing ions, e.g., Li⁺, to transmit through the electrolyte. The “solid electrolyte” according to the present invention means in particular any kind of material in which ions, for example, Li⁺, can move around while the material is in a solid state.

As used herein, the term “argyrodite,” or “argyrodite crystal” refers to a crystal structure or crystal bonding arrangement. This crystal structure or bonding arrangement is based on the crystal structure for the natural mineral, argyrodite, which is a silver germanium sulfide mineral characterized by the chemical formula Ag₈GeS₆. This crystal structure is also exemplified by the isomorphous argyrodite mineral, Ag₈SnS₆.

As used herein, the term “crystalline phase” refers to a material of a fraction of a material that exhibits a crystalline property, for example, well-defined x-ray diffraction peaks as measured by X-Ray Diffraction (XRD).

As used herein, the term “peaks” refers to (28) positions on the x-axis of an XRD powder pattern of intensity v. degrees (28) which have a peak intensity substantially greater than the background. In a series of XRD powder pattern peaks, the primary peak is the peak of highest intensity which is associated with the compound, or phase, being analyzed. The second primary peak is the peak of second highest intensity. The third primary peak is the peak of third highest intensity.

The term “electrochemical device” refers in particular to a device which generates and/or stores electrical energy by, for example, electrochemical and/or electrostatic processes. Electrochemical devices may include electrochemical cells such as batteries, notably solid state batteries. A battery may be a primary (i.e., single or “disposable” use) battery, or a secondary (i.e., rechargeable) battery.

As used herein, the terms “cathode” and “anode” refer to the electrodes of a battery. During a charge cycle in a Li-secondary battery, Li ions leave the cathode and move through an electrolyte and to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more different sources of power, for example both gasoline-powered and electric-powered vehicles.

### DETAILED INVENTION

The invention then relates to a solid material according to general formula (I)

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6.

The solid material of the invention is neutrally charged. It is understood that formula (I) is an empirical formula (gross formula) determined by means of elemental analysis. Accordingly, formula (I) defines a composition which is averaged over all phases present in the solid material.

X is preferably Cl.

Generally 0.01≤x≤0.35 and preferably 0.01≤x≤0.25, particularly 0.01≤x≤0.2. Generally 1.3≤y≤1.6 and particularly 1.3≤y≤1.5. In some embodiments 0.01≤x≤0.25 and 1.3≤y≤1.5. In some other embodiments 0.01≤x≤0.2 and 1.3≤y≤1.5.

The solid material of the invention may be amorphous (glass) and/or crystallized (glass ceramics). Only part of the solid material may be crystallized. The crystallized part of the solid material may comprise only one crystal structure or may comprise a plurality of crystal structures. The crystallization degree of the solid material (the crystallization degree of a crystal structure of which the ionic conductivity is higher than that of an amorphous body) is preferably comprised from 80% to 100%.

Solid material of the invention preferably comprises a fraction consisting of crystalline phases, wherein one of said crystalline phases has the argyrodite structure. Preferably said crystalline phase having the argyrodite phase makes from 90 to 100% of the total weight of the fraction consisting of crystalline phases. Such a fraction may be measured by X-Ray Diffraction by mean of Rietveld refinement of the total diffractogram. This refinement can be done with FullProf software by using multiphase refinement option.

Solid material of the invention may comprise structural units PS₄³⁻ and structural units PO₄³⁻, wherein preferably the ratio between the amount of structural units PS₄³⁻ and the amount of structural units PO₄³⁻ is in the range from 1000:1 to 9:1.

Solid material of the invention may comprise at least peaks at position of: 15.65°+/−0.5°, 25.53°+/−0.5°, 30.16°+/−0.5°, and 31.52°+/−0.5° (28) when analyzed by x-ray diffraction using CuKα radiation at 25° C.

The cristallographic space group of the solid material of the present invention is preferably space group 226 (F4̅3m). In this space group, cell parameters of the solid materials of the present invention may range from 9,680 Angstrom to 9,860 Angstrom, as measured by x-ray diffraction using CuKα radiation at 25° C., and further calculated with a dedicated software, such as Fullprof software, using a refinement method such as Rietveld and Le Bail refinement.

In some embodiments, solid materials of formula (I) according to the present invention may be as follows:

| x | y | Li | Mg | P | S | Cl |
|---|---|---|---|---|---|---|
| 0.01 | 1.3 | 5.68 | 0.01 | 1 | 4.7 | 1.3 |
| 0.05 | 1.3 | 5.6 | 0.05 | 1 | 4.7 | 1.3 |
| 0.0625 | 1.3 | 5.575 | 0.0625 | 1 | 4.7 | 1.3 |
| 0.075 | 1.3 | 5.55 | 0.075 | 1 | 4.7 | 1.3 |
| 0.1 | 1.3 | 5.5 | 0.1 | 1 | 4.7 | 1.3 |
| 0.125 | 1.3 | 5.45 | 0.125 | 1 | 4.7 | 1.3 |
| 0.15 | 1.3 | 5.4 | 0.15 | 1 | 4.7 | 1.3 |
| 0.2 | 1.3 | 5.3 | 0.2 | 1 | 4.7 | 1.3 |
| 0.25 | 1.3 | 5.2 | 0.25 | 1 | 4.7 | 1.3 |
| 0.01 | 1.325 | 5.655 | 0.01 | 1 | 4.675 | 1.325 |
| 0.05 | 1.325 | 5.575 | 0.05 | 1 | 4.675 | 1.325 |
| 0.0625 | 1.325 | 5.55 | 0.0625 | 1 | 4.675 | 1.325 |
| 0.075 | 1.325 | 5.525 | 0.075 | 1 | 4.675 | 1.325 |
| 0.1 | 1.325 | 5.475 | 0.1 | 1 | 4.675 | 1.325 |
| 0.125 | 1.325 | 5.425 | 0.125 | 1 | 4.675 | 1.325 |
| 0.15 | 1.325 | 5.375 | 0.15 | 1 | 4.675 | 1.325 |
| 0.2 | 1.325 | 5.275 | 0.2 | 1 | 4.675 | 1.325 |
| 0.25 | 1.325 | 5.175 | 0.25 | 1 | 4.675 | 1.325 |
| 0.01 | 1.35 | 5.63 | 0.01 | 1 | 4.65 | 1.35 |
| 0.05 | 1.35 | 5.55 | 0.05 | 1 | 4.65 | 1.35 |
| 0.0625 | 1.35 | 5.525 | 0.0625 | 1 | 4.65 | 1.35 |
| 0.075 | 1.35 | 5.5 | 0.075 | 1 | 4.65 | 1.35 |
| 0.1 | 1.35 | 5.45 | 0.1 | 1 | 4.65 | 1.35 |
| 0.125 | 1.35 | 5.4 | 0.125 | 1 | 4.65 | 1.35 |
| 0.15 | 1.35 | 5.35 | 0.15 | 1 | 4.65 | 1.35 |
| 0.2 | 1.35 | 5.25 | 0.2 | 1 | 4.65 | 1.35 |
| 0.25 | 1.35 | 5.15 | 0.25 | 1 | 4.65 | 1.35 |
| 0.01 | 1.375 | 5.605 | 0.01 | 1 | 4.625 | 1.375 |
| 0.05 | 1.375 | 5.525 | 0.05 | 1 | 4.625 | 1.375 |
| 0.0625 | 1.375 | 5.5 | 0.0625 | 1 | 4.625 | 1.375 |
| 0.075 | 1.375 | 5.475 | 0.075 | 1 | 4.625 | 1.375 |
| 0.1 | 1.375 | 5.425 | 0.1 | 1 | 4.625 | 1.375 |
| 0.125 | 1.375 | 5.375 | 0.125 | 1 | 4.625 | 1.375 |
| 0.15 | 1.375 | 5.325 | 0.15 | 1 | 4.625 | 1.375 |
| 0.2 | 1.375 | 5.225 | 0.2 | 1 | 4.625 | 1.375 |
| 0.25 | 1.375 | 5.125 | 0.25 | 1 | 4.625 | 1.375 |
| 0.01 | 1.4 | 5.58 | 0.01 | 1 | 4.6 | 1.4 |
| 0.05 | 1.4 | 5.5 | 0.05 | 1 | 4.6 | 1.4 |
| 0.0625 | 1.4 | 5.475 | 0.0625 | 1 | 4.6 | 1.4 |
| 0.075 | 1.4 | 5.45 | 0.075 | 1 | 4.6 | 1.4 |
| 0.1 | 1.4 | 5.4 | 0.1 | 1 | 4.6 | 1.4 |
| 0.125 | 1.4 | 5.35 | 0.125 | 1 | 4.6 | 1.4 |
| 0.15 | 1.4 | 5.3 | 0.15 | 1 | 4.6 | 1.4 |
| 0.2 | 1.4 | 5.2 | 0.2 | 1 | 4.6 | 1.4 |
| 0.25 | 1.4 | 5.1 | 0.25 | 1 | 4.6 | 1.4 |
| 0.01 | 1.425 | 5.555 | 0.01 | 1 | 4.575 | 1.425 |
| 0.05 | 1.425 | 5.475 | 0.05 | 1 | 4.575 | 1.425 |
| 0.0625 | 1.425 | 5.45 | 0.0625 | 1 | 4.575 | 1.425 |
| 0.075 | 1.425 | 5.425 | 0.075 | 1 | 4.575 | 1.425 |
| 0.1 | 1.425 | 5.375 | 0.1 | 1 | 4.575 | 1.425 |
| 0.125 | 1.425 | 5.325 | 0.125 | 1 | 4.575 | 1.425 |
| 0.15 | 1.425 | 5.275 | 0.15 | 1 | 4.575 | 1.425 |
| 0.2 | 1.425 | 5.175 | 0.2 | 1 | 4.575 | 1.425 |
| 0.25 | 1.425 | 5.075 | 0.25 | 1 | 4.575 | 1.425 |
| 0.01 | 1.45 | 5.53 | 0.01 | 1 | 4.55 | 1.45 |
| 0.05 | 1.45 | 5.45 | 0.05 | 1 | 4.55 | 1.45 |
| 0.0625 | 1.45 | 5.425 | 0.0625 | 1 | 4.55 | 1.45 |
| 0.075 | 1.45 | 5.4 | 0.075 | 1 | 4.55 | 1.45 |
| 0.1 | 1.45 | 5.35 | 0.1 | 1 | 4.55 | 1.45 |
| 0.125 | 1.45 | 5.3 | 0.125 | 1 | 4.55 | 1.45 |
| 0.15 | 1.45 | 5.25 | 0.15 | 1 | 4.55 | 1.45 |
| 0.2 | 1.45 | 5.15 | 0.2 | 1 | 4.55 | 1.45 |
| 0.25 | 1.45 | 5.05 | 0.25 | 1 | 4.55 | 1.45 |
| 0.01 | 1.5 | 5.48 | 0.01 | 1 | 4.5 | 1.5 |
| 0.05 | 1.5 | 5.4 | 0.05 | 1 | 4.5 | 1.5 |
| 0.0625 | 1.5 | 5.375 | 0.0625 | 1 | 4.5 | 1.5 |
| 0.075 | 1.5 | 5.35 | 0.075 | 1 | 4.5 | 1.5 |
| 0.1 | 1.5 | 5.3 | 0.1 | 1 | 4.5 | 1.5 |
| 0.125 | 1.5 | 5.25 | 0.125 | 1 | 4.5 | 1.5 |
| 0.15 | 1.5 | 5.2 | 0.15 | 1 | 4.5 | 1.5 |
| 0.2 | 1.5 | 5.1 | 0.2 | 1 | 4.5 | 1.5 |
| 0.25 | 1.5 | 5 | 0.25 | 1 | 4.5 | 1.5 |

The composition of the compound of formula (I) may notably be determined by chemical analysis using techniques well known to the skilled person, such as for instance a X-Ray Diffraction (XRD) and an Inductively Coupled Plasma-Mass Spectrometry (ICP-MS).

Solid materials of the invention may be in powder form. The powder may be characterized by its size or Particle Size Distribution (PSD). The size of the particles of the powder may be such that it presents:
a d50-value of less than 50 μm, for example less than 40 μm, less than 30 μm or less than 20 μm,
a d10-value higher than 0.05 μm, and/or
a d90-value of less than 100 μm, for example less than 90 μm, less than 80 μm or less than 70 μm,
   as measured by laser diffraction in para-xylene.

The powder may be constituted of particles which are aggregated.

The measurement of the particle size distribution (PSD), e.g. d50-value, d10-value and d90-value, may be performed with a scanning electronic microscope (SEM) on a number of particles, which is at least 150. Alternatively, it may be performed by laser diffraction in para-xylene.

The d50-value has the usual meaning used in the field of particle size distributions. The dn-value corresponds to the diameter of the particles for which n % of the particles have a diameter which is less than dn. d50 (median) is defined as the size value corresponding to the cumulative distribution at 50%. These parameters are usually determined from a distribution in volume of the diameters of a dispersion of the particles of the solid material in a solution, obtained with a laser diffractometer, using the standard procedure predetermined by the instrument software. The laser diffractometer uses the technique of laser diffraction to measure the size of the particles by measuring the intensity of light diffracted as a laser beam passes through a dispersed particulate sample. The laser diffractometer may be the Mastersizer 3000 manufactured by Malvern for instance.

D50 may be notably measured after treatment under ultrasound. The treatment under ultrasound may consist in inserting an ultrasonic probe into a dispersion of the solid material in a solution, and in submitting the dispersion to sonication.

The particles of the powder may be spheroidal in shape.

The particles of the powder may exhibit a sphericity ratio SR between 0.8 and 1.0, more particularly between 0.85 and 1.0, even more particularly between 0.90 and 1.0. SR may preferably be between 0.90 and 1.0 or between 0.95 and 1.0. The sphericity ratio of a particle is calculated from the measured perimeter P and area A of the projection of the particle using the following equation:

$$SR = 4 π A / {P}^{2}$$

For an ideal sphere, SR is 1.0 and it is below 1.0 for spheroidal particles. The SR may be determined by a Dynamic Image Analysis (DIA). An example of appliance that can be used to perform the DIA is the CAMSIZER®P4 of Retsch or the QicPic® of Sympatec. The sphericity ratio may be more particularly measured according to ISO 13322-2 (2006). The DIA generally requires the analysis of a large number of particles to be statistically meaningful (e.g. at least 500 or even at least 1000).

The powder of the present invention may also be characterized by a low emission of H₂S in given conditions. This feature may be measured by exposing the powder to a humid atmosphere and by measuring the quantity of H₂S released during the first 50 minutes at which the powder is in contact with said atmosphere.

The solid material may advantageously exhibit an ionic conductivity of at least 3.3 mS/cm, for example at least 3.4 mS/cm, for example between 3.5 and 15.0 mS/cm, or between 3.8 and 10.0 mS/cm as measured on pressed (500 MPa) pellets by impedance spectroscopy.

The measurement of the ionic conductivity is performed on a pressed pellet. Typically, a pressed pellet is manufactured using a uniaxial or isostatic pressure. When uniaxial pressure is applied to form the pellet, a pressure above 100 MPa, preferentially above 300 MPa, is applied for a duration of at least 30 seconds. The measurement is done under uniaxial pressure typically between 2 MPa and 200 MPa.

The invention also refers to a method for producing a solid material according to general formula (I) comprising at least bringing at least lithium sulfide, phosphorous sulfide, halogen compound and a magnesium compound, optionally in one or more solvents. One or more lithium sulfide, phosphorous sulfide, halogen compound and magnesium compound may be used.

Notably, the present invention concerns also a method for producing a solid material according to general formula (I) comprising at least reacting at least lithium sulfide, phosphorous sulfide, halogen compound and a magnesium compound, optionally in one or more solvents. One or more lithium sulfide, phosphorous sulfide, halogen compound and a magnesium compound may be used.

Solid materials of the invention may be produced by any methods used in the prior art known for producing a sulfide-based glass solid electrolyte, such as for instance a melt extraction method, a full solution method, a mechanical milling method or a slurry method in which raw materials are reacted, optionally in one or more solvents.

The invention then refers to a process for the preparation of a solid material according to general formula (I), said process comprising the steps of:
a) obtaining a composition by admixing the raw materials, optionally in one or more solvents;
b) optionally applying a mechanical treatment to the composition obtained in step a);
c) optionally removing at least a portion of the one or more solvents from the composition obtained on step b), so that to obtain a solid residue;
d) optionally pressing the solid residue from step c) into pellets;
e) heating the obtained residue obtained in step c) e.g. in the form of pellets, to a temperature in the range of from 350° C. to 580° C., under an inert atmosphere, for a time period ranging from 1 to 12 hours, thereby forming the solid material; and
f) optionally treating the solid material obtained in step e) to the desired particle size distribution.

In some embodiments step a) is performed under inert atmosphere. Inert atmosphere as used in step a) refers to the use of an inert gas; ie. a gas that does not undergo detrimental chemical reactions under conditions of the reaction. Inert gases are used generally to avoid unwanted chemical reactions from taking place, such as oxidation and hydrolysis reactions with the oxygen and moisture in air. Hence inert gas means gas that does not chemically react with the other reagents present in a particular chemical reaction. Within the context of this disclosure the term “inert gas” means a gas that does not react with the solid material precursors. Examples of an “inert gas” include, but are not limited to, nitrogen, helium, argon, carbon dioxide, neon, xenon, H₂S, O₂ with less than 1000 ppm of liquid and airborne forms of water, including condensation. The gas can also be pressurized.

It is preferred that stirring be conducted when the raw materials are brought into contact with each other under an atmosphere of an inert gas such as nitrogen or argon. The dew point of an inert gas is preferably −20° C. or less, particularly preferably −40° C. or less. The pressure may be from 0.0001 Pa to 100 MPa, preferably from 0.001 Pa to 20 MPa, preferably from 0.01 Pa to 0.5 MPa.

Preferably in step a), inert atmosphere comprises an inert gas such as H₂S, dry N₂, dry Argon or dry air (dry may refer to a gas with less than 800 ppm of liquid and airborne forms of water, including condensation).

The composition ratio of each element can be controlled by adjusting the amount of the raw material compound when the solid material is produced. The raw materials and their molar ratio are selected according to the target stoichiometry. The target stoichiometry defines the ratio between the elements Li, Mg, P, S and X, which is obtainable from the applied amounts of the precursors under the condition of complete conversion without side reactions and other losses.

Lithium sulfide refers to a compound including one or more of sulfur atoms and one or more of lithium atoms, or alternatively, one or more of sulfur containing ionic groups and one or more of lithium containing ionic groups. In certain preferred aspects, lithium sulfide may consist of sulfur atoms and lithium atoms. Preferably, lithium sulfide is Li₂S.

Phosphorus sulfide refers to a compound including one or more of sulfur atoms and one or more of phosphorus atoms, or alternatively, one or more of sulfur containing ionic groups and one or more of phosphorus containing ionic groups. In certain preferred aspects, phosphorus sulfide may consist of sulfur atoms and phosphorus atoms. Non-limiting exemplary phosphorus sulfide may include, but not limited to, P₂S₅, P₄S₃, P₄S₁₀, P₄S₄, P₄S₅, P₄S₆, P₄S₇, P₄S₈, and P₄S₉.

Halogen compound refers to a compound including one or more of halogen atoms such as F, Cl, Br, or I via chemical bond (e.g., ionic bond or covalent bond) to the other atoms constituting the compound. In certain preferred aspect, the halogen compound may include one or more of F, Cl, Br, I, or combinations thereof and one or more metal atoms. In other preferred aspect, the halogen compound may include one or more of F, Cl, Br, I, or combinations thereof and one or more non-metal atoms. Non-limiting examples may suitably include metal halide such as LiF, LiBr, LiCl, LiI, NaF, NaBr, NaCl, NaI, KaF, KBr, KCl, KI, and the like. In certain preferred aspect, the halogen compound suitably for the use in a solid electrolyte in all-solid Li-ion battery may include one or more halogen atoms and Li. Preferably, the halogen compound may be selected from the group consisting of lithium bromide (LiBr), lithium chloride (LiCl), lithium iodide (LiI) and combinations thereof.

Magnesium compound refers to a compound including one or more of Mg atoms via chemical bond (e.g., ionic bond or covalent bond) to the other atoms constituting the compound. In another aspect, magnesium compound can be metallic magnesium. In certain preferred aspect, the magnesium compound may include one or more Mg atoms one or more non-metal atoms, such as S, Cl or Br. Magnesium compound is preferably chosen in the group consisting of: MgS, MgCl₂ and mixture thereof.

Magnesium compound of the invention may also be a blend of metallic magnesium and elementary sulfur.

In some embodiments, lithium sulfide is Li₂S, phosphorous sulfide is P₂S₅, halogen compound is LiCl, and magnesium compound is selected from MgS, MgCl₂ and mixture thereof.

Preferably, the solid material of the invention is made by using at least the raw materials as follows: Li₂S, P₂S₅, LiCl and a magnesium compound selected from MgS, MgCl₂ and mixtures thereof. In some embodiments, the solid material of the invention is made by using at least the raw materials as follows: Li₂S, P₂S₅, LiCl and MgS. In some other embodiments, the solid material of the invention is made by using at least the raw materials as follows: Li₂S, P2S₅, LiCl and MgCl₂.

Preferably, lithium sulfide, phosphorous sulfide, halogen compound and a magnesium compound are in the form of powders which have an average particle diameter comprised between 0.5 μm and 400 μm. The particle size can be evaluated with SEM image analysis or laser diffraction analysis.

The solvent may suitably be selected from one or more of polar or non-polar solvents that may substantially dissolve at least one compound selected from: lithium sulfide, phosphorus sulfide, halogen compound and magnesium compound. Said solvent may also substantially suspend, dissolve or otherwise admix the above described components, e.g., lithium sulfide, phosphorus sulfide, halogen compound and magnesium compound.

Solvent of the invention then constitutes in step a) a continuous phase with dispersion of one or more of the above described components.

Depending on the components and the solvent, some of the components are then rather dissolved, partially dissolved or under a form of a slurry. (ie. component(s) is/are not dissolved and forming then a slurry with the solvent).

In certain preferred aspect, the solvent may suitably a polar solvent. Solvents are preferably polar solvents preferably selected in the group consisting of alkanols, notably having 1 to 6 carbon atoms, such as methanol, ethanol, propanol and butanol; carbonates, such as dimethyl carbonate; acetates, such as ethyl acetate; ethers, such as dimethyl ether; organic nitriles, such as acetonitrile; aliphatic hydrocarbons, such as hexane, pentane, 2-ethylhexane, heptane, decane, and cyclohexane; and aromatic hydrocarbons, such as tetrahydrofuran, xylenes and toluene.

It is understood that references herein to “a solvent” includes one or more mixed solvents.

An amount of about 1 wt % to 80 wt % of the powders mixture and an amount of about 20 wt % to 99 wt % of the solvent, based on the total weight of the powders mixture and the solvent, may be mixed. Preferably, an amount of about 25 wt % to 75 wt % of the powders mixture and an amount of 25 wt % to 75 wt % of the solvent, based on the total weight of the powders mixture and the solvent, may be mixed. Particularly, an amount of about 40 wt % to 60 wt % of the powders mixture and an amount of about 40 wt % to 60 wt % of the solvent, based on the total weight of the powders mixture and the solvent, may be mixed.

The temperature of step a) in presence of solvent is preferably between the fusion temperature of the selected solvent and ebullition temperature of the selected solvent at a temperature where no unwanted reactivity is found between solvent and admixed compounds. Preferably step a) is done between −20° C. and 40° C. and more preferably between 15° C. and 40° C. In absence of solvent step a) is done at a temperature between −20° C. and 200° C. and preferably between 15° C. and 40° C.

Duration of step a) is preferably between 1 minute and 1 hour.

Mechanical treatment to the composition in step b) may be performed by wet or dry milling; notably be performed by adding the powders mixture to a solvent and then milling at about 100 rpm to 1000 rpm, notably for a duration from 10 minutes to 80 hours more preferably for about 4 hours to 40 hours.

Said milling is also known as reactive-milling in the conventional synthesis of lithium argyrodites.

The mechanical milling method also has an advantage that, simultaneously with the production of a glass mixture, pulverization occurs.

In the mechanical milling method, various methods such as a rotation ball mill, a tumbling ball mill, a vibration ball mill and a planetary ball mill or the like can be used. Mechanical milling may be made with or without balls such as ZrO₂.

In such a condition, lithium sulfide, phosphorous sulfide, halogen compound and magnesium compound are allowed to react optionally in a solvent for a predetermined period of time.

The temperature of step b) in presence of solvent is between the fusion temperature of the selected solvent and ebullition temperature of the selected solvent at a temperature where no unwanted reactivity is found between solvent and compounds. Preferably step b) is done at a temperature between −20° C. and 80° C. and more preferably between 15° C. and 40° C. In absence of solvent step a) is done between −20° C. and 200° C. and preferably between 15° C. and 40° C.

Mechanical treatment to the composition in step b) may also be performed by stirring, notably by using well known techniques in the art, such as by using standard powder or slurry mixers.

Usually a paste or a blend of paste and liquid solvent may be obtained at the end of step b).

In step c), at least a portion of the solvent is removed notably means to remove at least about 30%, 40%, 50%, 60%, 70%, 80%, 90% 95% or 100%, of the total weight of a solvent used, or any ranges comprised between these values. Solvent removal may be carried out by known methods used in the art, such as decantation, filtration, centrifugation, drying or a combination thereof.

The temperature in step c) is selected to allow removal of solvent. Preferably when drying is selected as method for solvent removal, temperature is selected below ebullition temperature and as a function of vapor partial pressure of the selected solvent.

Duration of step c) is between 1 second and 100 hours, preferably between 1 hour and 20 hours. Such a low duration may be obtained for instance by using a flash evaporation, such as by spray drying.

It is preferred that step c) be conducted under an atmosphere of an inert gas such as nitrogen or argon. The dew point of an inert gas is preferably −20° C. or less, particularly preferably −40° C. or less. The pressure may be from 0.0001 Pa to 100 MPa, preferably from 0.001 Pa to 20 MPa, preferably from 0.01 Pa to 20 MPa. Notably the pressure may range from 0.0001 Pa to 0.001 Pa, notably by using ultravacuum techniques. Notably the pressure may range from 0.01 Pa to 0.1 MPa by using primary vacuum techniques.

In step d) the solid residue from step c) may be pressed into pellets. For example, the solid residue may be pressed in a mold to form the pellet. Molding can be performed with equipment well known by the person skilled in the art. For the sake of example, molding can be run using uniaxial press or single punch tableting machines In step e) the heating, or thermal treatment, of the residue obtained in step c) e.g. in the form of pellets, may notably allow to convert the amorphized powder mixture (glass) obtained above into a solid material crystalline or mixture of glass and crystalline (glass ceramics).

Heat treatment is carried out at a temperature in the range of from 350° C. to 580° C., for example from 370° C. to 550° C. or from 390° C. to 530° C., notably for a duration of 1 hour to 12 hours, more particularly from 2 hours to 10 hours or from 3 hours to 7 hours. Heat treatment may start directly at high temperature or via a ramp of temperature at a rate comprised between 1° C./min to 20° C./min. Heat treatment may finish with an air quenching or via natural cooling from the heating temperature or via a controlled ramp of temperature at a rate comprised between 1° C./min to 20° C./min.

Preferably in step e), inert atmosphere comprises an inter gas such as dry N₂, or dry Argon (dry may refer to a gas with less than 800 ppm of liquid and airborne forms of water, including condensation). Preferably in step e) the inert atmosphere is a protective gas atmosphere used in order to minimize, preferably exclude access of oxygen and moisture.

The pressure at the time of heating may be at normal pressure or under reduced pressure. The atmosphere may be inert gas, such as nitrogen and argon. The dew point of the inert gas is preferably −20° C. or less, with −40° C. or less being particularly preferable. The pressure may be from 0.0001 Pa to 100 MPa, preferably from 0.001 Pa to 20 MPa, preferably from 0.01 Pa to 20 MPa. Notably the pressure may range from 0.0001 Pa to 0.001 Pa, notably by using ultravacuum techniques. Notably the pressure may range from 0.01 Pa to 0.1 MPa by using primary vacuum techniques.

In step f), it is possible to treat the solid material to the desired particle size distribution. If necessary, the solid material obtained by the process according to the invention as described above is ground (e.g. milled) into a powder. Preferably, said powder has a D50 value of the particle size distribution of less than 50 μm, more preferably less than 10 μm, even more preferably less than 5 μm, as determined by means of dynamic light scattering or image analysis.

Preferably, said powder has a D90 value of the particle size distribution of less than 100 μm, more preferably less than 10 μm, even more preferably less than 5 μm, as determined by means of dynamic light scattering or image analysis. Notably, said powder has a D90 value of the particle size distribution comprised from 1 μm to 100.

The invention then also refers to a process for the preparation of a solid material according to general formula (I), said process comprising the steps of:
a′) obtaining a solution by admixing the raw materials in one or more solvents, under an inert atmosphere;
b′) removing at least a portion of the one or more solvents from the composition as obtained in step a′), so that to obtain a solid residue;
c′) optionally pressing the solid residue from step b′) into pellets;
d′) optionally heating the solid residue as obtained in step b′) e.g. in the form of pellets, at a temperature in the range of from 350° C. to 580° C., under an inert atmosphere, thereby forming the solid material; and
e′) optionally treating the solid material obtained in step d′) to the desired particle size distribution.

Various features of step a′) are basically similar to those of step a), such as for instance with respect to precursors and solvent. Preferably temperature in step a′) ranges from −200° C. to 100° C., preferably from −200° C. to 10° C.

Features in the removal of solvent as mentioned in step b′) may be similar to those ones as expressed in step c). Preferably in step b′), temperature is in the range of from 30° C. to 200° C., under an inert atmosphere, and preferably under a pressure 0.0001 Pa to 100 MPa.

In step c′) the solid residue from step b′) may be pressed into pellets as expressed in step d).

Heating of step d′) may be carried out with features as expressed in step e). Preferably at a temperature in the range of from 350° C. to 580° C., under an inert atmosphere and preferably under a pressure 0.0001 Pa to 100 MPa.

Features of treating the solid material as mentioned in step e′) may be similar to those ones as expressed in step f).

The invention also refers to a solid material of formula (I) as solid electrolyte, as well as a solid electrolyte comprising at least a solid material of formula (I).

Said solid electrolytes comprises then at least a solid material of formula (I) and optionally at least one lithium ion-conducting material (LiCM) other than the solid material of the invention, such as a lithium argyrodites, lithium thiophosphates, such as glass or glass ceramics Li₃PS₄, Li₇PS₁₁, and lithium conducting oxides such as lithium stuffed garnets Li₇La₃Zr₂O₁₂ (LLZO).

Said solid electrolytes may also optionally comprise polymers such as styrene butadiene rubbers, organic or inorganic stabilizers such as SiO₂ or dispersants.

The invention also concerns an electrochemical device comprising a solid electrolyte comprising at least a solid material of formula (I).

Preferably in the electrochemical device, particularly a rechargeable electrochemical device, the solid electrolyte is a component of a solid structure for an electrochemical device selected from the group consisting of cathode, anode and separator.

A further aspect of the present invention refers to batteries, more preferably to an alkali metal battery, in particular to a lithium battery comprising at least one inventive electrochemical device, for example two or more.

Electrochemical devices can be combined with one another in inventive alkali metal batteries, for example in series connection or in parallel connection.

The invention also concerns a solid state battery comprising a solid electrolyte comprising at least a solid material of formula (I).

Typically, a lithium solid-state battery includes a positive electrode active material layer containing a positive electrode active material, a negative electrode active material layer containing a negative electrode active material, and a solid electrolyte layer formed between the positive electrode active material layer and the negative electrode active material layer. At least one of the positive electrode active material layer, the negative electrode active material layer, and the solid electrolyte layer includes a solid electrolyte as defined above.

The cathode of an all-solid-state electrochemical device usually comprises beside an active cathode material as a further component a solid electrolyte. Also the anode of an all-solid state electrochemical device usually comprises a solid electrolyte as a further component beside an active anode material.

The form of the solid structure for an electrochemical device, in particular for an all-solid-state lithium battery, depends in particular on the form of the produced electrochemical device itself. The present invention further provides a solid structure for an electrochemical device wherein the solid structure is selected from the group consisting of cathode, anode and separator, wherein the solid structure for an electrochemical device comprises a solid material according to the invention.

A plurality of electrochemical cells may be combined to an all solid-state battery, which has both solid electrodes and solid electrolytes.

The solid material disclosed above may be used in the preparation of an electrode. The electrode may be a positive electrode or a negative electrode.

The electrode typically comprises:
a metal substrate;
directly adhered onto said metal substrate, at least one layer made of a composition comprising:
(i) a solid material of formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6;
(ii) at least one electro-active compound (EAC);
(iii) optionally at least one lithium ion-conducting material (LiCM) other than the solid material of the invention;
(iv) optionally at least one electro-conductive material (ECM);
(v) optionally a lithium salt (LIS);
(vi) optionally at least one polymeric binding material (P).

Numbers x and y may belong to the ranges previously described.

The electro-active compound (EAC) denotes a compound which is able to incorporate or insert into its structure and to release lithium ions during the charging phase and the discharging phase of an electrochemical device. An EAC may be a compound which is able to intercale and deintercalate into its structure lithium ions. For a positive electrode (cathode), the EAC may be a composite metal chalcogenide of formula LiMeQ₂ wherein:
Me is at least one metal selected in the group consisting of Co, Ni, Fe, Mn, Cr, Al and V;
Q is a chalcogen such as O or S.

The EAC may more particularly be of formula LiMeO₂. Preferred examples of EAC include LiCoO₂, LiNiO₂, LiMnO₂, LiNiₓCo₁₋ₓO₂ (0<x<1), LiNiₓCo_{y}Mn_{z}O₂ (0<x, y, z<1 and x+y+z=1) for instance LiNi_{1/3}Mn_{1/3}Co_{1/3}O₂, LiNi_{0.6}Mn_{0.2}Co_{0.2}O₂, LiNi_{0.8}Mn_{0.1}Co_{0.1}O₂, Li(NiₓCo_{y}Al_{z})O₂ (x+y+z=1) and spinel-structured LiMn₂O₄ and Li (Ni_{0.5}Mn_{1.5})O₄.

The EAC may also be a lithiated or partially lithiated transition metal oxyanion-based electro-active material of formula M₁M₂(JO₄)_{f}E_{1-f}, wherein:
M₁ is lithium, which may be partially substituted by another alkali metal representing less that 20% of M₁;
M₂ is a transition metal at the oxidation level of +2 selected from Fe, Co, Mn, Ni or mixtures thereof, which may be partially substituted by one or more additional metals at oxidation levels between +1 and +5 and representing less than 35% of the M₂ metals, including 0;
JO₄ is any oxyanion wherein J is either P, S, V, Si, Nb, Mo or a combination thereof;
E is a fluoride, hydroxide or chloride anion;
f is the molar fraction of the JO₄ oxyanion, generally comprised between 0.75 and 1.

The M₁M₂(JO₄)_{f}E_{1-f} electro-active material as defined above is preferably phosphate-based. It may exhibit an ordered or modified olivine structure. For a positive electrode, the EAC may also be sulfur or Li₂S.

For a positive electrode, the EAC may also be a conversion-type materials such as FeS₂ or FeF₂ or FeF₃

For a negative electrode, the EAC may be selected in the group consisting of graphitic carbons able to intercalate lithium. More details about this type of EAC may be found in Carbon 2000, 38, 1031-1041. This type of EAC typically exist in the form of powders, flakes, fibers or spheres (e.g. mesocarbon microbeads).

The EAC may also be: lithium metal; lithium alloy compositions (e.g. those described in U.S. Pat. No. 6,203,944 and in WO 00/03444); lithium titanates, generally represented by formula Li₄Ti₅O₁₂; these compounds are generally considered as “zero-strain” insertion materials, having low level of physical expansion upon taking up the mobile ions, i.e. Li⁺; lithium-silicon alloys, generally known as lithium silicides with high Li/Si ratios, in particular lithium silicides of formula Li_{4.4}Si and lithium-germanium alloys, including crystalline phases of formula Li_{4.4}Ge. EAC may also be composite materials based on carbonaceous material with silicon and/or silicon oxide, notably graphite carbon/silicon and graphite/silicon oxide, wherein the graphite carbon is composed of one or several carbons able to intercalate lithium.

The ECM is typically selected in the group consisting of electro-conductive carbonaceous materials and metal powders or fibers. The electron-conductive carbonaceous materials may for instance be selected in the group consisting of carbon blacks, carbon nanotubes, graphite, graphene and graphite fibers and combinations thereof. Examples of carbon blacks include ketjen black and acetylene black. The metal powders or fibers include nickel and aluminum powders or fibers.

The lithium salt (LIS) may be selected in the group consisting of LiPF₆, lithium bis(trifluoromethanesulfonyl)imide, lithium bis(fluorosulfonyl)imide, LiB(C₂O₄)₂, LiAsF₆, LiClO₄, LiBF₄, LiAlO₄, LiNO₃, LiCF₃SO₃, LiN(SO₂CF₃)₂, LiN(SO₂C₂F₅)₂, LiC(SO₂CF₃)₃, LiN(SO₃CF₃)₂, LiC₄FeSO₃, LiCF₃SO₃, LiAlCl₄, LiSbF₆, LiF, LiBr, LiCl, LiOH and lithium 2-trifluoromethyl-4,5-dicyanoimidazole.

The function of the polymeric binding material (P) is to hold together the components of the composition. The polymeric binding material is usually inert. It preferably should be also chemically stable and facilitate the electronic and ionic transport. The polymeric binding material is well known in the art. Non-limitative examples of polymeric materials (P) include notably: (1) VDF or TFE based polymers, notably in the form of copolymers, block copolymers or graft copolymers; (2) hydrogenated or non-hydrogenated diene-based rubber polymers, notably in the form of block copolymers and graft polymers such as polyisobutylene (PIB), styrene-butadiene rubber (SBR), (hydrogenated) acrylonitrile butadiene rubber ((h)NBR), styrene-ethylene-butylene-styrene (SEBS) and the like; (3) polymers comprising at least one alkyl (meth)acrylate, notably in the form of copolymers, block copolymers and graft copolymers, such as polymethylmethacrylate (PMMA), polybutylacrylate (BA), styrene-butylacrylate (ST-BA), styrene methylacrylate (ST-MA), butylacrylate-acrylonitrile (BA-CN) and the like; (4) polysaccharide based polymers, copolymers, block copolymers and graft copolymers such as carboxymethylcellulose (CMC), guar and the like; (5) polymers based on acrylonitrile, notably in the form of copolymers block copolymers and graft polymers such as poly(acrylonitrile) (PAN), acrylonitrile-methylacrylate (PAN-MA), styrene-acrylonitrile (SAN) acrylonitrile-styrene-acrylate (ASA) and the like; (6) polyamideimide (PAI) polymers, copolymers, block copolymers and graft polymers.

The polymeric material (P) may be selected in the list consisting of vinylidenefluoride (VDF)-based (co)polymers. The polymeric material (P) may more particularly be a copolymer comprising or consisting of units of VDF and hexafluoropropylene (HFP).

The polymeric material (P) may be selected in the list consisting of the optionally hydrogenated thermoplastic elastomers based on styrene. The polymeric material (P) may more particularly be a styrene-butadiene rubber (SBR) or a styrene-ethylene-butylene-styrene (SEBS).

The polymeric material (P) may be selected in the list consisting of polymers comprising units of acrylonitrile. The polymeric material (P) may more particularly be a copolymer of acrylonitrile, butadiene and/or butyl acrylate.

The proportion of the solid material of the invention in the composition may be between 0.1 wt % to 80 wt %, based on the total weight of the composition. In particular, this proportion may be between 1.0 wt % to 60 wt %, more particularly between 5 wt % to 30 wt %. The thickness of the electrode is not particularly limited and should be adapted with respect to the energy and power required in the application. For example, the thickness of the electrode may be between 0.01 mm to 1.000 mm.

The solid material of the invention may also be used in the preparation of a separator. A separator is an ionically permeable membrane placed between the anode and the cathode of a battery. Its function is to be permeable to the lithium ions while blocking electrons and assuring the physical separation between the electrodes.

The separator of the invention typically comprises at least:
a solid material of formula (I) as follows:

Li_{7-2x-y}MgₓPS_{6-y}X_{y} (I)

wherein:
X is a halogen selected from the group consisting of F, Cl, I and Br or a combination thereof;
x is a number such as 0.01≤x≤0.35 and
y is a number such as 1.3≤y≤1.6;
optionally at least one polymeric binding material (P);
optionally at least one metal salt, notably a lithium salt;
optionally at least one plasticizer.

Numbers x and y may belong to the ranges previously described.

The electrode and the separator may be prepared using methods well-known to the skilled person. This usually comprises mixing the components in an appropriate solvent and removing the solvent. For instance, the electrode may be prepared by the process which comprises the following steps:
a slurry comprising the components of composition and at least one solvent is applied onto the metal substrate;
the solvent is removed.

Usual techniques known to the skilled person are the following ones: coating and calendaring, dry and wet extrusion, 3D printing, sintering of porous foam followed by impregnation. Usual techniques of preparation of the electrode and of the separator are provided in Journal of Power Sources, 2018 382, 160-175. Other techniques such as extrusion, paste extrusion, (electro)spray coating, kneading followed by calendaring may be used.

The electrochemical devices, notably batteries such as solid state batteries described herein, can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants.

The electrochemical devices, notably batteries such as solid state batteries described herein, can notably be used in motor vehicles, bicycles operated by electric motor, robots, aircraft (for example unmanned aerial vehicles including drones), ships or stationary energy storages. Preferred are mobile devices such as are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

Should the disclosure of any patents, patent applications, and publications which are incorporated herein by reference conflict with the description of the present application to the extent that it may render a term unclear, the present description shall take precedence.

### Experimental Part

### X-Ray Diffraction

X-Ray diffraction of the samples were collected with an Aeris Research diffractometer from Malvern Panalytical (Cu, 600 W, 40 kV and 15 mA, Soller slit 0.02°). The diffractograms were collected in the 10° to 90° range in 2 hours. The lattice parameters were determined by fitting the diffraction profiles using Full-Prof Suite. Profile fitting was performed using the F-4 3 M space group of argyrodite.

### Conductivity & Electrochemical Impedance Spectroscopy (EIS)

To perform impedance spectroscopy, the powders were sandwiched between two pre-dried carbon paper electrodes (Papyex soft graphite, 0.2 mm thick from Mersen) and cold pressed into 6 mm die at 500 MPa (Uniaxial manual press MS15-MDD, Eurolabo). The obtained pellets were then loaded into an airtight measurement cell (EQ-PSC from MTI). All the measurements were performed under a pressure of 40 MPa.

The AC impedance spectra were collected using a Biologic VMP3 while the temperature of the sample was controlled by a binder thermostatic chamber. The cell is connected to the galvanostat-potentiostat and the PEIS spectra is recorded with the conditions a 20 mV sinusoidal perturbation around OCV from 1 MHz to 10 kHz, 25 points recorded per decade, each point averaged from 50 measures. A model circuit was used to fit the curve and extract ionic resistance. The temperature test is performed with steps of 2 h at each temperature, at the end of which a spectrum is recorded. The temperature is set from −20° C. to 60° C. and back to 30° C.

Electronic conductivity is measured by DC measurement at 2 Volts and determined after 1 hour by the asymptotic method.

The EIS measurements indicate that the LiPSMgX solid materials according to the invention have an improved ionic conductivity and a lower activation energy when compared to conductivity and activation energy of LiPSMgX material according to prior art.

Should the disclosure of any patents, patent applications, and publications which are incorporated herein by reference conflict with the description of the present application to the extent that it may render a term unclear, the present description shall take precedence.

### EXAMPLES

### Comparative Example 1: Synthesis of Li₆PS₅Cl

In an Ar filled glovebox, Li₂S (Lorad Chemical), LiCl (Sigma-Aldrich) and P₂S₅ (Sigma-Aldrich) were weighed and mixed in stoichiometric proportions to obtain 4 g of the desired composition of Li₆PS₅Cl. The mixture was then transferred into a 45 mL ZrO₂ jar filled with 5 mm zirconia (YSZ) balls. The ball to powder ratio was fixed at 16.5. The jar was sealed, taken out of the glovebox and placed in a Fritsch Planetary Micro Mill Pulverisette 7. Mixture was ball milled with 500 RPM rotating speed for 2 hours while employing 15 minutes breaks every 30 minutes of milling. The powder was recovered in the Ar filled glovebox (<1 ppm H₂0, <1 ppm O₂). The resulting powder was transferred into a closed SiC crucible. The crucible was heated to 500° C. with 5° C./min heating rate in a tube furnace under N₂ atmosphere and was kept at this temperature for 12 hours. The sample was then cooled down to RT. It was recovered in the Ar filled glovebox and deagglomerated in a mortar.

Argyrodite phase was identified and pure with cell parameter of 9.8519 Å. Ionic conductivity at 30° C. was 3.2 mS/cm, associated with an activation energy of 0.38 eV. Electronic conductivity at 30° C. was 4×10⁻⁹ S/cm.

### Comparative Example 2: Synthesis of Li_{5.25}Mg_{0.25}PS_{4.75}Cl_{1.25}

In an Ar filled glovebox, Li₂S (Lorad Chemical), LiCl (Sigma-Aldrich), MgCl₂ (Sigma-Aldrich) and P₂S₅ (Sigma-Aldrich) were weighed and mixed in stoichiometric proportions to obtain 4 g of the desired composition of Li_{5.25}Mg_{0.25}PS_{4.75}Cl_{1.25}. The mixture was then transferred into a 45 mL ZrO₂ jar filled with 5 mm zirconia (YSZ) balls. The ball to powder ratio was fixed at 16.5. The jar was sealed, taken out of the glovebox and placed in a Fritsch Planetary Micro Mill Pulverisette 7. Mixture was ball milled with 500 RPM rotating speed for 2 hours while employing 15 minutes breaks every 30 minutes of milling. The powder was recovered in the Ar filled glovebox (<1 ppm H₂0, <1 ppm O₂). The resulting powder was transferred into a closed SiC crucible.

The crucible was heated to 500° C. with 5° C./min heating rate in a tube furnace under N₂ atmosphere and was kept at this temperature for 12 hours. The sample was then cooled down to RT. It was recovered in the Ar filled glovebox and deagglomerated in a mortar. Argyrodite phase was identified and quasi pure. Some traces of MgS were also observed. Argyrodite cell parameter was 9.8188 Å. Ionic conductivity at 30° C. was 2.6 mS/cm, associated with an activation energy of 0.38 eV. Electronic conductivity at 30° C. was 2×10⁻⁹ S/cm.

### Comparative Example 3: Synthesis of Li_{5.8}Mg_{0.1}PS₅Cl

Comparative example 3 was performed like comparative example 2 with adapted proportions to obtain 4 g of the desired composition Li_{5.8}Mg_{0.1}PS₅Cl. Argyrodite phase was identified and pure with cell parameter of 9.8457 Å. Ionic conductivity at 30° C. was 1.6 mS/cm, associated with an activation energy of 0.38 eV. Electronic conductivity at 30° C. was 3.10⁻⁹ S/cm.

### Example 1: Synthesis of Li_{5.375}Mg_{0.125}PS_{4.625}Cl_{1.375}

Example 1 was performed like comparative example 2 with adapted proportions to obtain 4 g of the desired composition Li_{5.375}Mg_{0.125}PS_{4.625}Cl_{1.375}.

Argyrodite phase was identified and pure with cell parameter of 9.8131 Å. Ionic conductivity at 30° C. was 5.4 mS/cm, associated with an activation energy of 0.38 eV. Electronic conductivity at 30° C. was 1×10⁻⁸ S/cm.

### Example 2: Synthesis of Li_{5.375}Mg_{0.0625}PS_{4.5}Cl_{1.5}

Example 2 was performed like comparative example 2 with adapted proportions to obtain 4 g of the desired composition Li_{5.375}Mg_{0.0625}PS_{4.5}Cl_{1.5}.

Argyrodite phase was identified and pure with cell parameter of 9.8067 Å. Ionic conductivity at 30° C. was 5.8 mS/cm, associated with an activation energy of 0.36 eV. Electronic conductivity at 30° C. was 4.10⁻⁹ S/cm.

It is clear from the examples that, the solid materials according to general formula Li_{7-2x-y}MgₓPS_{6-y}X_{y} (I) within the composition range according to the invention i.e. defined by 0.01≤x≤0.35 and by 1.3≤y≤1.6, have very high ionic conductivity and low activation energy as well as low electronic conductivity.

Comparative examples show that despite the fact that pure argyrodite phase can be obtained out of the composition range according to the invention, the resulting solid materials have much lower ionic conductivity.

1. A solid material according to general formula (I) as follows:
Li_{7-2x-y}MgₓPS_{6-y}X_{y} (I)
wherein:
X is a halogen selected from the group consisting of F, Cl, I and Br or a combination thereof;
x is a number such as 0.01≤x≤0.35 and
y is a number such as 1.3≤y≤1.6.

2. The solid material according to claim 1, wherein X is Cl.

3. The solid material according to claim 1, wherein
0.01≤x≤0.25 and
1.3≤y≤1.5.

4. The solid material according to claim 1 which is according to any one of the following formulas: Li_{5.375}Mg_{0.125}PS_{4.625}Cl_{1.375}; Li_{5.375}Mg_{0.0625}PS_{4.5}Cl_{1.5}.

5. The solid material according to claim 1, presenting an ionic conductivity of at least 3.3 mS/cm, as measured on pressed (500 MPa) pellets by impedance spectroscopy.

6. The solid material according to claim 1, wherein the solid material is in powder form with a distribution of particle diameters, presenting:
a d50-value of less than 50 μm,
a d10-value higher than 0.05 μm, and/or
a d90-value of less than 100 μm,
as measured by laser diffraction in para-xylene.

7. A process for preparation of the solid material according to claim 1 comprising the steps of:
a) obtaining a composition by admixing the raw materials, optionally in one or more solvents;
b) optionally applying a mechanical treatment to the composition obtained in step a);
c) optionally removing at least a portion of the one or more solvents from the composition obtained on step b), with formation of a solid residue;
d) optionally pressing the solid residue from step c) into pellets;
e) heating the obtained residue obtained in step c) to a temperature in a range of from 350° C. to 580° C., under an inert atmosphere, for a time period ranging from 1 to 12 hours, thereby forming the solid material; and
f) optionally treating the solid material obtained in step e) to a desired particle size distribution.

8. The process according to claim 7 wherein in step b) the mechanical treatment is performed by wet or dry milling.

9. A process for preparation of the solid material according to claim 1 comprising the steps of:
a′) obtaining a solution by admixing raw materials in one or more solvents;
b′) removing at least a portion of the one or more solvents from the composition obtained in step a′), with formation of a solid residue;
c′) optionally pressing the solid residue from step b′) into pellets;
d′) optionally heating the obtained residue obtained in step b′) to a temperature in the range of from 350° C. to 580° C., under an inert atmosphere, for a time period ranging from 1 to 12 hours, thereby forming the solid material; and
e′) optionally treating the solid material obtained in step d′) to a desired particle size distribution.

10. The process according to claim 7 wherein the raw materials are at least lithium sulfide (Li₂S), phosphorous sulfide (P₂S₅), lithium chloride (LiCl), and a magnesium compound selected from magnesium sulfide (MgS), magnesium chloride (MgCl₂) and mixture thereof.

11. A solid material obtained by the process according to claim 7.

12. (canceled)

13. A solid electrolyte comprising at least the solid material according to claim 1.

14. An electrode comprising at least:
a metal substrate;
directly adhered onto said metal substrate, at least one layer made of a composition comprising:
(i) the solid material according to claim 1;
(ii) at least one electro-active compound (EAC);
(iii) optionally at least one lithium ion-conducting material (LiCM) other than the solid material;
(iv) optionally at least one electro-conductive material (ECM);
(v) optionally a lithium salt (LIS); and
(vi) optionally at least one polymeric binding material (P).

15. A separator comprising at least:
the solid material according to claim 1;
optionally at least one polymeric binding material (P);
optionally at least one metal salt; and
optionally at least one plasticizer.

16. The separator according to claim 15, wherein the at least one metal salt is a lithium salt.
